(19) United States
(12) Patent Application Publication
(10) Pub. No.: US 2025/0211120 A1
(43) Pub. Date: Jun. 26, 2025

(54) OUTPUT CONDUCTION DETECTION IN A BUCK CONVERTER

(71) Applicant: POWER INTEGRATIONS, INC., SAN JOSE, CA (US)

(72) Inventors: NOAM EZRA, Cambridge (GB); David Michael Hugh Matthews, Los Gatos, CA (US); Antonius Jacobus Johannes Werner, Cambridge (GB)

(73) Assignee: POWER INTEGRATIONS, INC., SAN JOSE, CA (US)

(21) Appl. No.: 18/393,347

(22) Filed: Dec. 21, 2023

(51) Int. Cl. H02M 3/158; H02M 1/00

(52) U.S. Cl. CPC H02M 3/1588; H02M 1/0019

(57) ABSTRACT

An integrated controller for a buck converter has an output conduction detector circuit that provides the input or high side of the controller with visibility of the discharge period and thereby prevents continuous current mode operation in case of a short-circuited output. The controller receives a feedback signal indicative of an output voltage of the buck converter and produces an input drive signal. A bias drive circuit receives the input drive signal and produces a bias drive signal. A bias supply circuit includes a bias transistor and and a bias diode. The bias drive transistor receives the bias drive signal. When the bias drive signal is asserted, the bias transistor conducts such that there is a voltage drop across the bias transistor. The output conduction detector circuit coupled to the bias transistor detects the voltage drop and produces an output conduction signal.

### CROSS-REFERENCE TO RELATED APPLICATION

This application relates to power converter having an integrated self-bias function described in the following applications filed concurrently herewith. The related application, all of which is incorporated herein by reference: U.S. patent application Ser. No. ______, of David Michael Hugh Matthews; entitled “Self Biasing the Input Controller in a Power Converter”.

### FIELD OF THE INVENTION

The present invention relates generally to power converters, and more specifically to buck converters. Even more specifically, the present invention relates to detecting output conduction in buck converters.

### BACKGROUND

Electric utilities transmit unregulated alternating current (ac), which carries electrical signals across long distances and between buildings. This transmission requires a very high voltage that most circuits, e.g., electronic devices, within houses and businesses cannot handle. The voltage needs to be stepped down to be used in those settings. Switched mode power converters, also referred to as switching power converters, are commonly used to provide a lower voltage to many of today's electronics due to their high efficiency, small size, and low weight. The switched mode power converter converts high voltage related to the unregulated ac input, to a lower voltage related to a constant or stable direct current (dc) output also known as a regulated dc output through an energy transfer element, e.g., a transformer. The switched mode power converter usually provides dc output regulation by sensing one or more signals representative of one or more output quantities, for example, voltage, current, or the combination of the two, and controlling the output in a closed loop. In operation, a switch is used to provide the desired output by varying the duty cycle, the switching frequency, or varying the number of pulses per unit time of the switch in a switched mode power converter.

Power converters generally include one or more controllers which sense and regulate the output of the power converter. These controllers generally require a regulated or unregulated voltage source to power the circuit components of the controller. In high voltage buck converters for automotive applications, e.g., 30-1000V input voltage, continuous current mode (CCM) operation is problematic due to the slow recovery of the output conductor circuit, e.g., the free-wheeling diode or the synchronous rectifier. As such this mode of operation is to be avoided.

The input or high side of the controller has typically no visibility of the discharge period and thus cannot prevent CCM operation in case of a short-circuited output.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 illustrates an example of a power converter that uses a controller having an integrated input side bias self-supply and an output conduction detector in accordance with teachings of the present invention.

FIG. 2 illustrates an example functional block diagram of a buck converter 10 including output conduction detection.

FIG. 3 illustrates another example functional block diagram of a buck converter 10 including output conduction detection.

FIG. 4 is an example of a logic diagram corresponding to the output conduction detector circuit 38 shown in FIG. 2 and FIG. 3.

FIG. 5 shows timing diagram waveforms to describe the operation of the converter shown in FIG. 2 or FIG. 3. Duration t₁-t₂ describes output conduction detection when the output current I2 flows through the bias transistor of the bias supply circuit 40. Duration t₄-t₈ describes output conduction detection when the bias capacitor is charged.

FIG. 6 is a process flowchart 100 for output conduction detection as shown in the waveforms of FIG. 5.

FIG. 7 illustrates an example functional block diagram 8 of the integrated controller 12 with an integrated input side bias self-supply function connected as a buck converter./

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted to facilitate a less obstructed view of these various embodiments of the present invention.

### DETAILED DESCRIPTION

In the following description, numerous specific details are set forth to provide a thorough understanding of the present invention. It will be apparent, however, to one having ordinary skill in the art that the specific detail need not be employed to practice the present invention. In other instances, well-known materials or methods have not been described in detail to avoid obscuring the present invention.

Reference throughout this specification to “one embodiment”, “an embodiment”, “one example” or “an example” means that a particular feature, structure, or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or subcombinations in one or more embodiments or examples. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

The embodiments disclosed are directed towards output conduction detection for a buck converter having a controller coupled to an input switch, e.g., a high side switch, an output conductor circuit, e.g., a output diode or switch, an inductive storage element, a feedback circuit, and an output filter circuit. The controller including a control circuit for the input switch and the output conductor circuit, a bias drive circuit coupled to a bias transistor, a bias diode, and an output conduction detector. The buck converter may be synchronous or non-synchronous. The control circuit coupled to detect the voltage across the bias switch. The bias switch has an output coupled to the inductive storage element. The bias diode has a first end coupled to an input of the bias switch and to an output of the output switch and has a second end coupled to the bias capacitor. The output filter circuit delivers energy to the bias transistor when the bias control signal is asserted. The output filter circuit stores energy in the bias capacitor when the bias control signal is deasserted.

The additional current sense for the bias transistor or drain voltage sense allows visibility of the output conduction period. During the output conduction period, there is a freewheeling current I2 through the output path (either the buck synchronous rectifier SR or freewheeling diode) and either the bias transistor or the bias diode of the bias supply circuit. This freewheeling current I2 raises the voltage on the drain of the bias transistor above the source of the input switch/above the bias voltage when it is directed through the bias diode (the bias transistor is non-conducting).

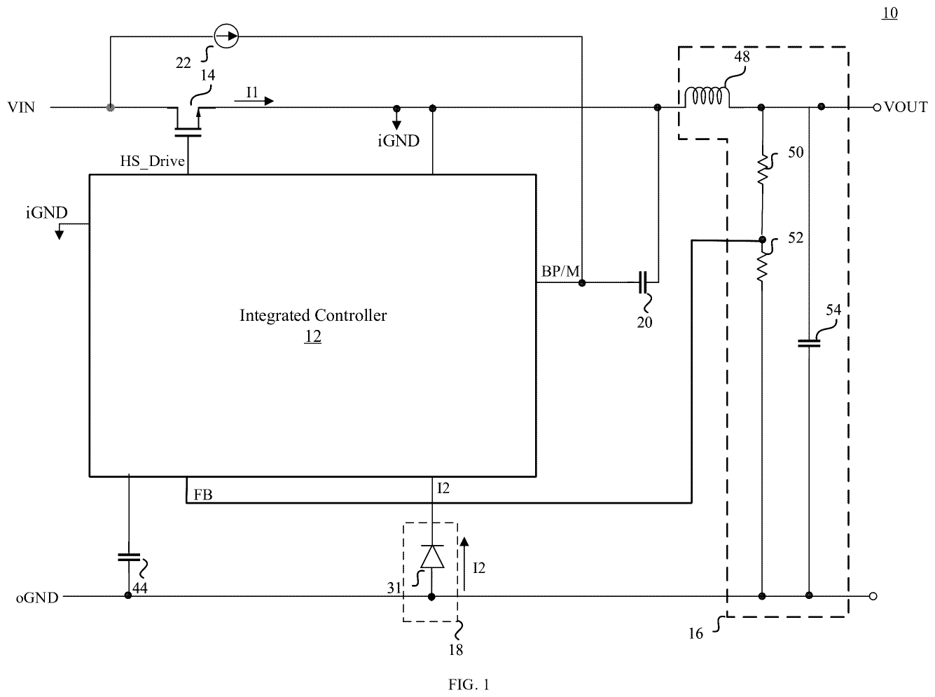

FIG. 1 illustrates an example schematic diagram of a buck converter 10 that uses an integrated controller 12. The integrated controller 12 includes an integrated input side bias self-supply and an output conduction detector in accordance with teachings of the present invention.

The output voltage of the buck converter 10 is sensed directly with feedback resistors 50 and 52 on the output side of the buck converter 10. The integrated controller 12 couples to an input switch 14, an output filter circuit 16, and an output conductor circuit 18. A bias capacitor 20 is coupled from a bias node BP/M of the integrated controller 12 to the output filter circuit 16. The drain of the input switch 14 is coupled to the Vin terminal of the power supply (not shown) and the source of the input switch 14 is coupled to the output filter circuit 16 and to input side ground iGND. A current source 22 is coupled to the drain of the input switch 14 and to the bias node BP/M.

The output filter circuit 16 illustratively includes an inductive storage element 48, feedback resistors 50, 52, and an output capacitor 54. The inductive storage element 48 is coupled between the source of the input switch 14 and the terminal VOUT. Feedback resistors 50, 52 are coupled between the terminal VOUT and output side ground oGND. The node between the feedback resistors 50, 52 may be accessed to provide a feedback signal FB to the integrated controller 12. The feedback signal FB is indicative of the voltage provided at the output of the buck converter. The output capacitor 54 is coupled between the terminal VOUT and output side ground oGND.

An output conductor circuit 18, e. g. at least one diode 31, is coupled between the output side ground oGND and the pin D of the integrated controller 12.

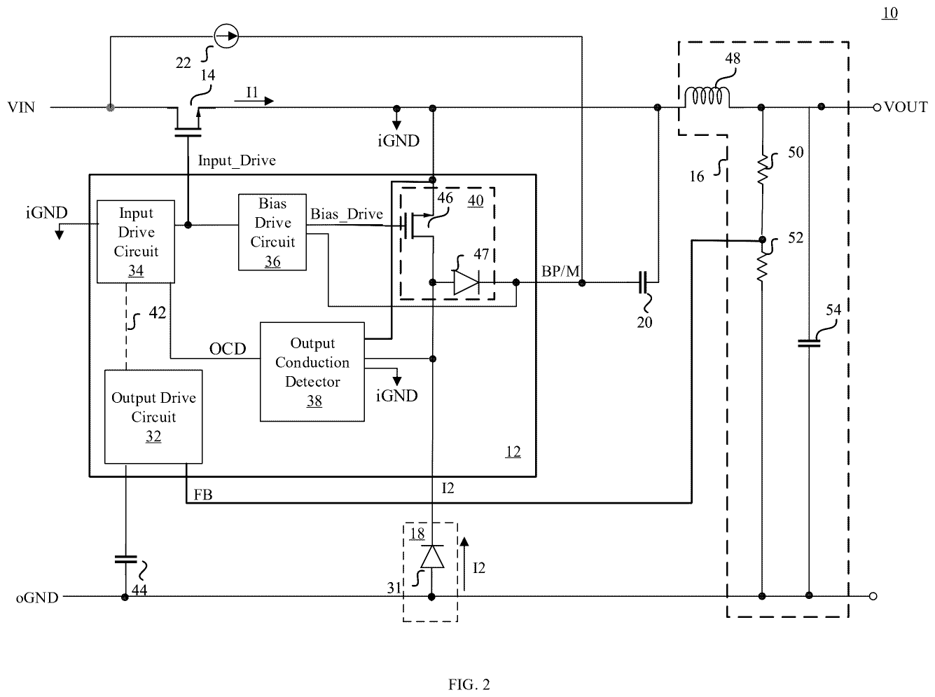

FIG. 2 illustrates an example functional block diagram of the integrated controller 12 with an integrated input side bias self-supply function connected as a buck converter 10.

The controller 12 includes an output drive circuit 32, an input drive circuit 34, a bias drive circuit 36, an output conduction detector circuit 38, and may include the bias supply circuit 40. The controller 12 facilitates communication between the input and output sides of the buck converter. The bias drive circuit 36 may be included as part of the input drive circuit 34. The gate of the input switch 14 receives an Input_Drive signal from the input circuit 34. A drive capacitor 44 is coupled between the output drive circuit 32 and the output side ground oGND. The output conduction detector circuit 38 is coupled across the bias supply circuit 40 and sends an output conduction detector (OCD) signal to the input drive circuit 34. The OCD signal indicates the detection of an output conduction event.

The bias supply circuit 40 is coupled to the bias drive circuit 36 and to the source of the HS switch 14. The bias supply circuit 40 includes a bias transistor 46 and a bias diode 47. The bias transistor 46 has a gate that receives the Bias_Drive signal from the bias drive circuit 36 and a source coupled to the input side ground iGND. The anode of the bias diode 47 is coupled to the drain of the bias transistor 46. The negative terminal of the bias capacitor 20 is coupled to the input side ground iGND and the cathode of the bias diode 47. The bias node BP/M between the bias diode 47 and the bias capacitor 20 may be accessed to provide voltage data to the bias drive circuit 36.

In operation, the feedback information derived from feedback resistors 50, 52 is communicated to the input drive circuit 34 from the output drive circuit 32. The input drive circuit 34 provides an Input_Drive signal to the bias drive circuit 36 which in turn provides the Bias_Drive signal to the gate of bias transistor 46. Thus, based on the state of the Input_Drive signal, the freewheeling current I2 is available to the output filter circuit 16 when the bias transistor 46 is conducting or the freewheeling current I2 is diverted through bias diode 47 into the bias capacitor 20 when bias transistor 46 is in non-conducting. The voltage across the bias supply circuit 40 is received by the output conduction detector circuit 38.

The output conduction detector circuit 38 determines the voltage across bias transistor 46. If the voltage is above a threshold voltage, an OCD signal is sent to the input drive circuit 34. The OCD signal indicates that there is an output conduction event. In response to the assertion of the OCD signal, the input drive circuit 34 may disable the Input_Drive signal.

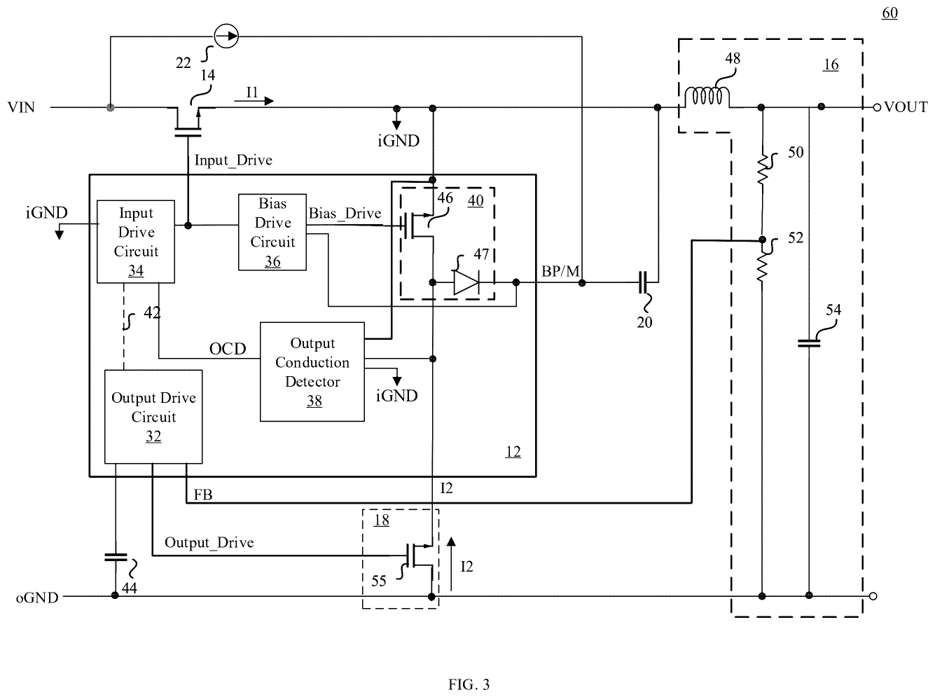

FIG. 3 illustrates another example functional block diagram of a buck converter 60 including output conduction detection. In this embodiment, the output conductor circuit 18 is a synchronous rectifier 55. The synchronous rectifier 55 has lower losses when used as an output switch, compared to the diode. It also enables zero voltage switching of the buck converter 60.

The output conduction detector circuit 38 is coupled across the bias transistor 46 and detects the drain to source voltage VDS across the bias transistor 46. The voltage VDS is proportional to the current during the output conduction period of the buck converter. The voltage VDS varies between 0 V and the combined voltage of the voltage across the bias capacitor 20 (V_{CBP}) and the voltage across the bias transistor 46 (V_{BIAS})

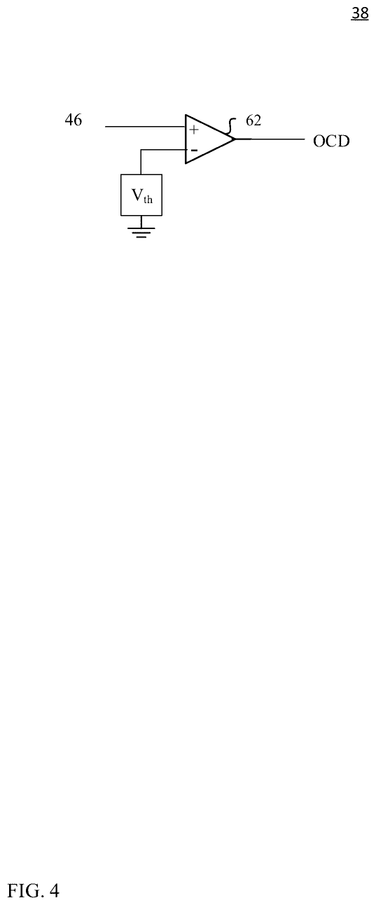

FIG. 4 is an example of a logic diagram corresponding to the output conduction detector circuit 38 shown in FIG. 2 and FIG. 3.

A comparator 62 has a positive input coupled to receive the voltage at the drain of the bias transistor 46 and a negative input coupled to the threshold voltage Vₜₕ. If the output of the second comparator 62 shows that the drain to source voltage (VDS) across the bias transistor 46 is above the threshold voltage Vₜₕ, then output conduction has been detected, e.g. the output conduction detection (OCD) signal is asserted.

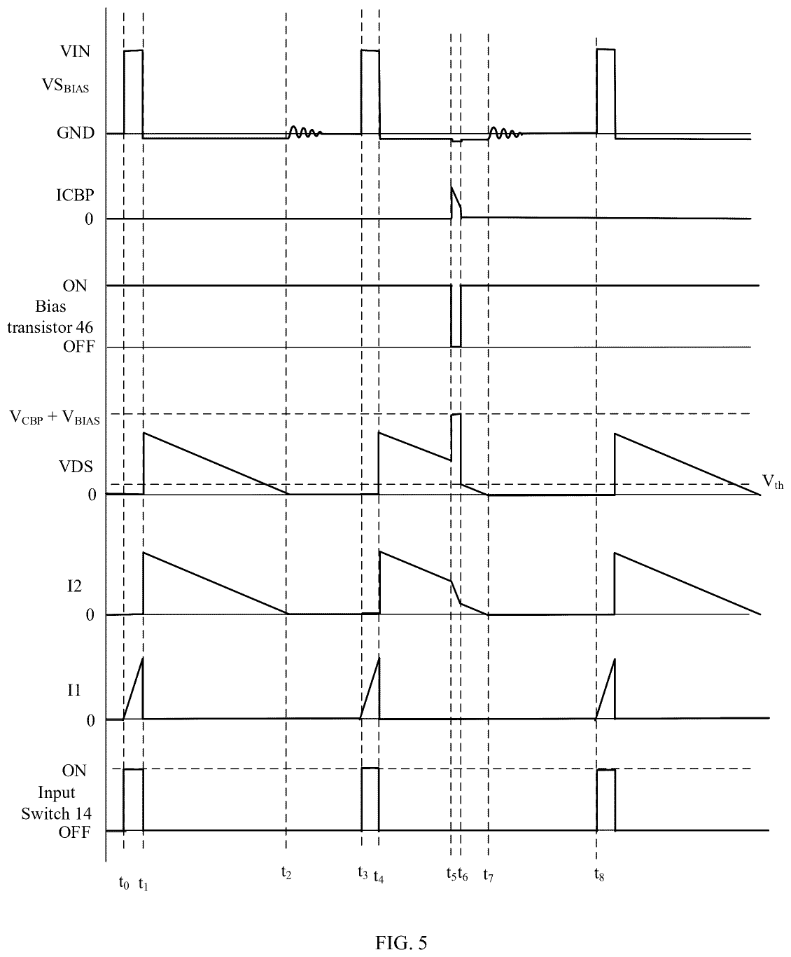

FIG. 5 shows timing diagram waveforms to describe the output conduction detection of the converter shown in FIG. 2 or FIG. 3. Duration t₁-t₂ describes when the output side current I2 or freewheeling current flows through the bias transistor 46 of the bias supply circuit 40. Duration t₅-t₆ describes an output conduction detection event while the bias capacitor 20 is charged. The voltage at the source of the bias transistor 46 VS_{BIAS} corresponds to the voltage at output of the input switch 14.

At time t₀, the input switch 14 is conducting until time t₁. During that time, the primary current I1 ramps in the input switch 14 and the inductive storage element 48. The switching cycle shown prior to t₀ is one where the bias transistor 46 remains on the whole time such that the bias capacitor 20 is not recharged. ICBP is the current that flows to the bias capacitor 20. When the bias capacitor is not recharged, ICBP is 0. The input drive circuit 34 controls the switching of the bias transistor 46 to perform the regulation of voltage across the bias capacitor 20.

At time t₁, the input switch 14 is non-conducting and the freewheeling current I2 is established flowing through the diode 31 and the bias transistor 46. The bias transistor 46 is conducting. The voltage across input switch 14 is approximately the input voltage Vin to the buck converter plus the total forward drop across the diode 31 and resistive drop across the bias transistor 46. The resistive drop across the bias transistor 46 is proportional to the freewheeling current I2.

At time t₂, the energy stored in the inductive storage element 48 at time t₁ has decayed to zero and the freewheeling current I2 is zero. At this time, the voltage across the input switch 14 reduces to an average value of (Vin-Vout) although it rings around this voltage at a frequency determined by the parasitic capacitance and inductance value associated with the inductor 48.

At time t₃, the input switch 14 is conducting until time t₄. During that time, the primary current I1 ramps in the input switch 14 and the inductive storage element 48. The switching cycle shown prior to t₃ is one where the bias transistor 46 remains conducting such that the bias capacitor 20 is not recharged. The input drive circuit 34 controls the switching of the bias transistor 46 to perform the regulation of voltage across the bias capacitor 20.

At time t₄, the input switch 14 is non-conducting and the freewheeling current I2 is established flowing through the output conductor circuit 18 and the bias transistor 46. The bias transistor 46 is conducting. The voltage across the input switch 14 is approximately the input voltage Vin plus the total forward drop across the output conductor circuit 18 and the resistive drop across bias transistor 46. During the output conduction period, the resistive drop across the bias transistor 46 is proportional to the freewheeling current I2.

At time t₅, the input drive circuit 34 detects the need to replenish the charged stored in the bias capacitor 20 and places the bias transistor 46 into a non-conducting state. ICBP is the current flowing into the bias capacitor during replenishment. At this time, the voltage across the input switch 14 increases to Vin plus the total forward drops across the output conductor circuit 18 and the bias diode 47 plus the voltage on the bias capacitor 20 to maintain the flow of the freewheeling current I2. ICBP is now equal to the freewheeling current I2. The freewheeling current I2 flows into the bias capacitor 20.

The di/dt slope in the freewheeling current I2 increases from period t₅ to t₆ due to the higher voltage in the freewheeling current path, e.g., the voltage on the bias capacitor 20 is added to the freewheeling path.

At time t₆, the input drive circuit 34 detects that no further charge is required to be stored in the bias capacitor 20 and places the bias transistor 46 into a non-conducting state.

At time t₇, the energy stored in the inductive storage element 48 at time t₄ has decayed to zero and the freewheeling current I2 is zero. At this time, the voltage across the input switch 14 reduces to an average value of (Vin-Vout) although it rings around this voltage at a frequency determined by the parasitic capacitance and inductance value associated with the inductive storage element 48.

From t₆ to t₇, the di/dt of the freewheeling current I2 is substantially the same as the di/dt of freewheeling current I2 between times t₄ and t₅.

At time t₈, another converter switching cycle is initiated when the input switch 14 begins to conduct.

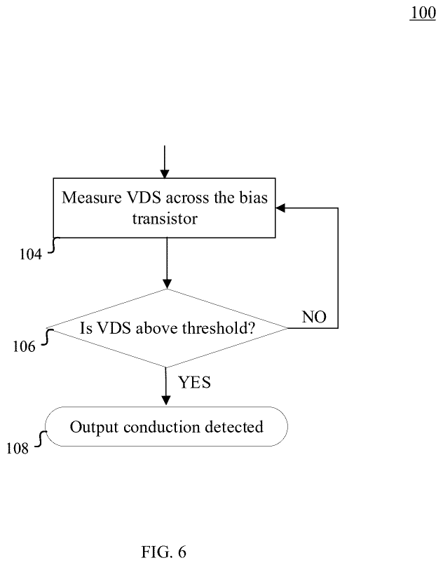

FIG. 6 is a process flowchart 100 output conduction detection as shown in the timing diagram waveforms of FIG. 4.

In step 104, the input drive circuit 34 measures the voltage VDS across the bias transistor 46.

In step 106, it is determined if the voltage VDS across the bias transistor 46 is above a threshold voltage Vₜₕ. If no, output conduction is not detected, repeat from step 102. If yes, in step 108, output conduction is detected.

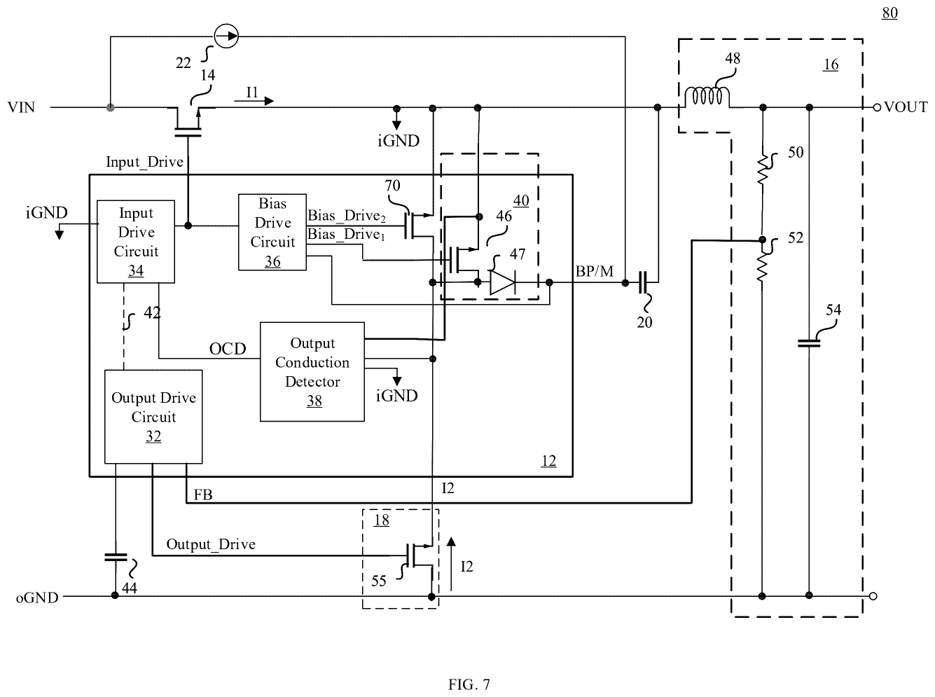

FIG. 7 illustrates an example functional block diagram 80 of the integrated controller 12 with an integrated input side bias self-supply function connected as a buck converter.

The controller 12 includes an output drive circuit 32, an input drive circuit 34, a bias drive circuit 36, an output conduction detector circuit 38, and may include the bias supply circuit 40. The controller 24 facilitates communication between the input and output sides of the power converter. The bias drive circuit 36 may be included as part of the input drive circuit 34. The gate of the input switch 14 receives an Input_Drive signal from the input drive circuit 34. An output drive capacitor 44 is coupled between the output drive circuit 32 and the output side ground oGND. The output conduction detector circuit 38 is coupled across the bias supply circuit 40 and sends an output conduction detector (OCD) signal to the input drive circuit 34. The OCD signal indicates the detection of an output conduction event.

The bias supply circuit 40 is coupled to the bias drive circuit 36 and to the source of the input switch 14. The bias supply circuit 40 includes a first bias transistor 46, a second bias transistor 70, and a bias diode 47. The first bias transistor 46 has a gate that receives the Bias_Drive₁ signal from the bias drive circuit 36 and a source coupled to the input side ground iGND. The second bias transistor 46 has a gate that receives the Bias_Drive₂ signal from the bias drive circuit 36 and a source coupled to the input side ground iGND. The anode of the bias diode 47 is coupled to the drain of the first and the second bias transistors 70, 46. The negative terminal of a bias capacitor 20 is coupled to the input side ground iGND and the cathode of the bias diode 47. The bias node BP/M between the bias diode 47 and the bias capacitor 20 may be accessed to provide voltage data to the bias drive circuit 36.

The second bias transistor 70 has a higher RdsON value than the first bias transistor 70.

In operation, the first and second bias transistor 46, 70 are driven at the same time by the bias drive circuit 36. When the secondary discharge time is over, e.g. the Bias_Drive₁ signal is deasserted, the second bias transistor 70, the Bias_Drive₂ signal remains asserted in case there is residual freewheeling current I2 that would increase the voltage on the drain of the second bias transistor. This may allow the detection of lower freewheeling current discharge.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

Although the present invention is defined in the claims, the present invention can alternatively be defined in accordance with the following examples:

Example 1. An integrated controller for a buck converter comprising: a controller coupled to receive a feedback signal indicative of an output voltage of the buck converter and responsive to the feedback signal to produce an input drive signal; a bias drive circuit coupled to the controller and responsive to the input drive signal to produce a bias drive signal; a bias supply circuit comprising, a bias transistor having a gate coupled to receive the bias drive signal, and a bias diode, an anode of the bias diode coupled to a drain of the bias transistor and a cathode of the bias diode coupled to the bias drive circuit, wherein the bias transistor, responsive to the bias drive signal being asserted, conducts such that there is a voltage drop across the bias transistor; and an output conduction detector circuit coupled to a source and to a drain of the bias transistor, the output conduction detector circuit responsive to detecting the voltage drop to produce an output conduction signal.

Example 2. The integrated controller of example 1, the output conduction detector circuit comprising a comparator coupled to compare a voltage at the drain of the bias transistor and a threshold voltage and to produce the output conduction detector signal.

Example 3. The controller of example 2, wherein the input drive circuit and the output drive circuit are included in a single integrated circuit package.

Example 4. The controller of example 3, wherein the input drive circuit and the output drive circuit are included in a monolithic integrated circuit.

Example 5. A buck converter comprising: an input switch; an output filter circuit coupled to the input switch, the output filter circuit configured to produce a feedback signal indicative of the output voltage of the buck converter; a bias capacitor coupled to the output filter circuit; an output conductor circuit coupled to the output filter circuit; a controller coupled to the output filter circuit, the controller comprising, an output drive circuit coupled to receive the feedback signal; an input drive circuit coupled the output drive circuit; the input drive circuit responsive to the feedback signal to produce an input drive signal; a bias drive circuit coupled to the bias capacitor and to the input drive circuit, the bias drive circuit responsive to the input drive signal to produce a bias drive signal; a bias supply circuit comprising, a bias transistor having a gate coupled to receive the bias drive signal, and a bias diode, an anode of the bias diode coupled to a drain of the bias transistor and a cathode of the bias diode coupled to the bias drive circuit, wherein the bias transistor, responsive to the bias drive signal being asserted conducts such that there is voltage drop across the bias transistor; and an output conduction detector circuit coupled to the source and to a drain of the bias transistor, and responsive to the detection of a voltage drop across the bias transistor to produce an output conduction signal.

Example 6. The buck converter of example 5, the output conduction detector circuit comprising a comparator coupled to compare a voltage the drain of the bias transistor and a threshold voltage.

Example 7. The buck converter of example 6, the output conductor circuit comprising at least one diode.

Example 8. The buck converter of example 6, wherein: the output drive circuit is coupled to produce an output drive signal in response to the feedback signal; and the output conductor circuit is a switch coupled to the output drive circuit, the switch coupled to receive the output drive signal and in response deliver current to one of the bias diode and the bias transistor.

1. An integrated controller for a buck converter comprising:
a controller coupled to receive a feedback signal indicative of an output voltage of the buck converter and responsive to the feedback signal to produce an input drive signal;
a bias drive circuit coupled to the controller and responsive to the input drive signal to produce a bias drive signal;
a bias supply circuit comprising,
a bias transistor having a gate coupled to receive the bias drive signal, and
a bias diode, an anode of the bias diode coupled to a drain of the bias transistor and a cathode of the bias diode coupled to the bias drive circuit,
wherein the bias transistor responsive to the bias drive signal being asserted conducts such that there is a voltage drop across the bias transistor; and
an output conduction detector circuit coupled to a source and to a drain of the bias transistor, the output conduction detector circuit responsive to detecting the voltage drop to produce an output conduction signal.

2. The integrated controller as in claim 1, the output conduction detector circuit comprising a comparator coupled to compare a voltage at the drain of the bias transistor and a threshold voltage to produce the output conduction detector signal.

3. The controller as in claim 2, wherein the input drive circuit and the output drive circuit are included in a single integrated circuit package.

4. The controller as in claim 3, wherein the input drive circuit and the output drive circuit are included in a monolithic integrated circuit.

5. A buck converter comprising:
an input switch;
an output filter circuit coupled to the input switch, the output filter circuit configured to produce a feedback signal indicative of the output voltage of the buck converter;
a bias capacitor coupled to the output filter circuit;
an output conductor circuit coupled to the output filter circuit;
a controller coupled to the output filter circuit, the controller comprising,
an output drive circuit coupled to the output filter circuit, the output drive circuit configured to receive the feedback signal;
an input drive circuit coupled the output drive circuit, the input drive circuit responsive to the feedback signal to produce an input drive signal;
a bias drive circuit coupled to the bias capacitor and to the input drive circuit, the bias drive circuit responsive to the input drive signal to produce a bias drive signal;
a bias supply circuit comprising,
a bias transistor having a gate coupled to receive the bias drive signal, and
a bias diode, an anode of the bias diode coupled to a drain of the bias transistor and a cathode of the bias diode coupled to the bias drive circuit,
wherein the bias transistor, responsive to the bias drive signal being asserted, conducts such that there is voltage drop across the bias transistor; and
an output conduction detector circuit coupled to the source and to a drain of the bias transistor, and responsive to the detection of a voltage drop across the bias transistor to produce an output conduction signal.

6. The buck converter as in claim 5, the output conduction detector circuit comprising a comparator coupled to compare a voltage the drain of the bias transistor and a threshold voltage.

7. The buck converter as in claim 6, the output conductor circuit comprising at least one diode.

8. The buck converter as in claim 6, wherein:
the output drive circuit is coupled to produce an output drive signal in response to the feedback signal; and
the output conductor circuit is a switch coupled to the output drive circuit, the switch coupled to receive the output drive signal and in response deliver current to one of the bias diode and the bias transistor.
